(19) United States
(12) Patent Application Publication
(10) Pub. No.: US 2023/0105017 A1
(43) Pub. Date: Apr. 6, 2023

(54) THERMAL CONTROL SET POINT METHOD

(71) Applicant: Gentherm Incorporated, Northville, MI (US)

(72) Inventor: Ioannis Androulakis, Livonia, MI (US)

(21) Appl. No.: 17/800,675

(22) PCT Filed: Mar. 18, 2021
(86) PCT No.: PCT/US2021/022885

§ 371 Date: Aug. 18, 2022

Related U.S. Application Data
(60) Provisional application No. 63/015,020, filed on Apr. 24, 2020.

(51) Int. Cl. B60H 1/00; B60N 2/56

(52) U.S. Cl. CPC B60H 1/0073; B60H 1/00742; B60H 1/0075; B60N 2/56

(57) ABSTRACT

A method for controlling an occupant microclimate system includes determining an occupant personal parameter, determining a vehicle environmental condition, predicting an initial set point value for a plurality of thermal effectors associated with the occupant from a portion of a master dataset based on the occupant personal parameter3 and the vehicle environmental condition, and regulating the plurality of thermal effectors based upon the initial set point values.

### CROSS-REFERENCE TO RELATED APPLICATION

This application claims priority to U.S. Provisional Patent Application No. 63/015,020 filed on Apr. 24, 2020.

### BACKGROUND

Thermal control methods are generally based either on individual thermal effector set points estimated in a lab environment or calculated as indirect single scalar metrics, such as the equivalent homogenous temperature (EHT). Such metrics have a proven value above macro thermal control methods, such as thermal control systems based on a single temperate value. However, in order for such indirect single metrics to work correctly, comfort evaluators must rely on some type of mathematical simulation that estimates heat generation from the human subjects, often incorrectly or with poor success.

Further, these mathematical simulations are often an estimate based on oversimplifications that fail to accurately predict metabolic heat generation and therefore comfort outside of a certain body mass index range, age range, and physical parameter range (occupant height and weight). Finally, these simulations do not account well for female occupants, which have metabolic heat generation and thermal comfort preferences which are different from male occupants.

There exists a need for an improved method of thermal control wherein recommending or predicting set points for individual heating/cooling devices, also known as thermal effectors 15, is based on a wide range of real-world data instead of inaccurate models or simulations.

### SUMMARY OF THE INVENTION

An exemplary method for controlling an occupant microclimate system, the method including the steps of determining an occupant personal parameter, determining a vehicle environmental condition, predicting an initial set point value for a plurality of thermal effectors associated with the occupant from a portion of a master dataset based on the occupant personal parameter and the vehicle environmental condition, and regulating the plurality of thermal effectors based upon the initial set point values.

In another example of the above described method for controlling an occupant microclimate system the predicting step includes selecting data subsets from a master dataset based on the occupant personal parameter and the vehicle environmental condition to create a reduced dataset, wherein the data subsets include set point values for the plurality of thermal effectors, and extracting initial set point values for the plurality thermal effectors from the reduced dataset.

In another example of any of the above described methods for controlling an occupant microclimate system the occupant personal parameter includes one of an occupant height, occupant weight and an occupant gender.

In another example of any of the above described methods for controlling an occupant microclimate system the vehicle environmental condition includes one of a vehicle exterior temperature and a solar load.

Another example of any of the above described methods for controlling an occupant microclimate system the step of determining an occupant personal parameter further includes the step of predicting an occupant clothing resistance based on the occupant personal parameter and the vehicle environmental condition.

In another example of any of the above described methods for controlling an occupant microclimate system the step of selecting data subsets from the master dataset, the occupant personal parameter is the predicted occupant clothing resistance.

In another example of any of the above described methods for controlling an occupant microclimate system the step of selecting data subsets from the master dataset includes selecting data with a range of values based on the occupant personal parameter and the vehicle environmental condition.

In another example of any of the above described methods for controlling an occupant microclimate system the master dataset includes a plurality of data subsets including an operating value.

In another example of any of the above described methods for controlling an occupant microclimate system the operating value in the data subsets is a thermal comfort value obtained by physical testing.

In another example of any of the above described methods for controlling an occupant microclimate system the operating value in the data subsets is an energy expenditure value of a thermal effector.

Another example of any of the above described methods for controlling an occupant microclimate system further includes the step of selecting data subsets from a predetermined dataset based the operating value, wherein the selected data subsets have an operating value with a probability higher than a predetermined threshold.

In another example of any of the above described methods for controlling an occupant microclimate system the step of extracting initial set point values for the plurality thermal effectors 15 from the reduced dataset comprises selecting an initial set point value that is one of the median and the mean of the reduced dataset.

In another example of any of the above described methods for controlling an occupant microclimate system the step of predicting an initial set point value for a plurality of thermal effectors 15, includes inverse mapping a portion of a master dataset to create an equation for the initial set point value.

In another example of any of the above described methods for controlling an occupant microclimate system the thermal effectors are proximal to the occupant and configured to provide thermal energy to the occupant.

In another example of any of the above described methods for controlling an occupant microclimate system the thermal effectors are disposed in a seat for the occupant.

Another example of any of the above described methods for controlling an occupant microclimate system further includes the step of obtaining an input from the occupant and adjusting a set point value of the thermal effector.

In another example of any of the above described methods for controlling an occupant microclimate system the master dataset is determined via real world empirical testing and live occupants.

In another example of any of the above described methods for controlling an occupant microclimate system the predicting an initial set point value includes selecting an initial set point value from a look-up table using the occupant personal parameter and vehicle environmental condition.

Another example of any of the above described methods for controlling an occupant microclimate system further includes the step of regulating the thermal effector to a second set point value, different than the initial set point value after the step of regulating the thermal effector to the initial set point value.

In another example of any of the above described methods for controlling an occupant microclimate system the step of regulating the plurality of thermal effectors is performed by a controller that regulates a plurality of thermal controllers for a plurality of occupants.

In another example of any of the above described methods for controlling an occupant microclimate system the occupant personal parameter includes an occupant age, wherein the occupant age is obtained from an occupant's electronic device.

In another example of any of the above described methods for controlling an occupant microclimate system the vehicle environmental condition includes a vehicle location, wherein the vehicle location is obtained via at least one of an occupant's device and a GPS signal received by the vehicle.

### BRIEF DESCRIPTION OF THE DRAWINGS

The disclosure can be further understood by reference to the following detailed description when considered in connection with the accompanying drawings wherein:

FIG. 1A is a flow chart depicting an example method of collecting data associated with a thermal control system.

FIG. 1B is a set of example charts depicting data collected from the method of FIG. 1A.

FIG. 2 is a flow chart depicting an example method of predicting an initial set point value for thermal effectors 15 in a vehicle microclimate system.

FIG. 3A is a schematic depicting a vehicle microclimate control system for a seated occupant.

FIG. 3B schematically illustrates the controller used for the vehicle microclimate control system.

FIG. 4A illustrates a set of charts graphically depicting an example variance in clothing resistance across a group of occupants and temperature ranges.

FIG. 4B illustrates a set of charts graphically depicting an example variance in clothing resistance across a group of occupants of varying height and temperature ranges.

FIG. 5 is an example method for predicting an initial set point value based on the collected data.

FIG. 6 is an example method of predicting an initial set point value based on the collected data.

FIG. 7 is an example look-up table for predicting an initial set point value.

The embodiments, examples and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

### DETAILED DESCRIPTION

Preferably thermal effectors function as a system, such as a microclimate system wherein several thermal effectors are associated with an occupant, to improve the thermal comfort of the occupant. The present disclosure includes the use of an improved method that uses a wide variety of real-world data from many occupants of varying physical parameters, preferences and metabolic heat generation rates. However, a wide variety of real-world data means that the size of the data to be analysed and utilized is prohibitively large, resulting in an increased processing time and/or high memory usage.

The process disclosed herein accounts for data records collected from real world data collection under varying environmental conditions and many different drivers as subjects. Therefore, the method and thus the recommended or predicted set points, takes into account real world variance observed in and out of passenger cabins, and also other factors that are not typically modelled or capable of being modelled in a mathematical model, simulation, or other machine learning tools.

The real-world data collected is analysed using a machine learning thermal comfort prediction algorithm that was developed to predict on a binary state (thermal comfort/discomfort) with a certain probability for both genders, all ages, and weights and height combinations. In some examples, the machine learning thermal comfort prediction algorithm is further configured to minimize energy expenditure of the thermal effectors as a constraint during the learning process. The method disclosed herein provides an improved prediction of the set points for the thermal effectors.

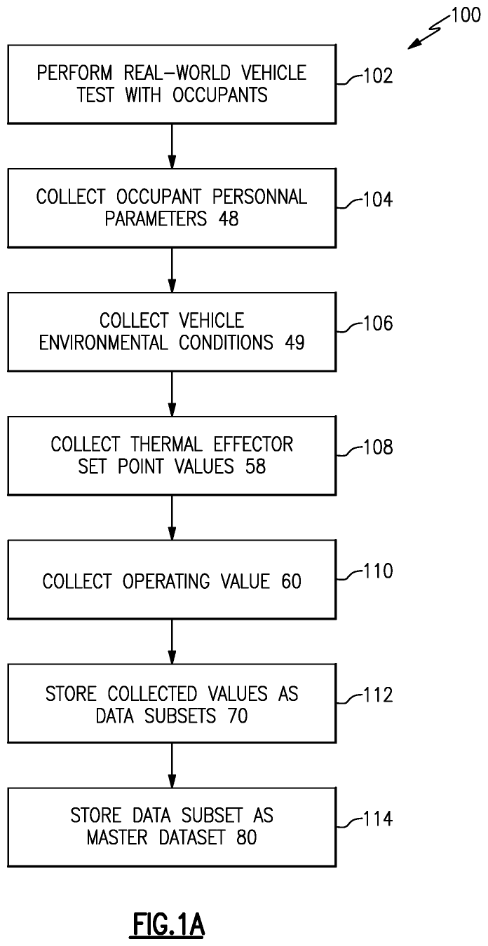

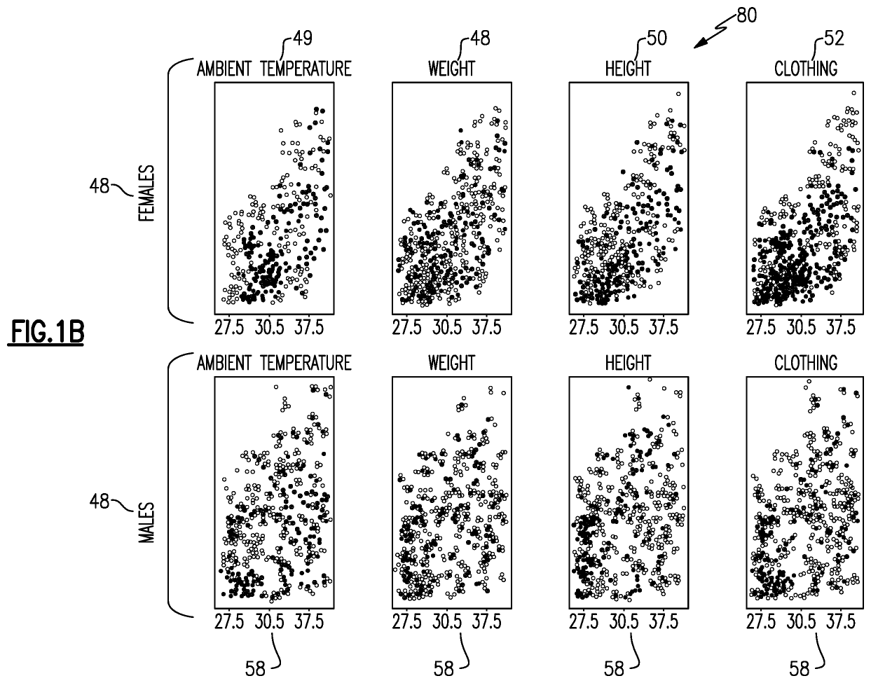

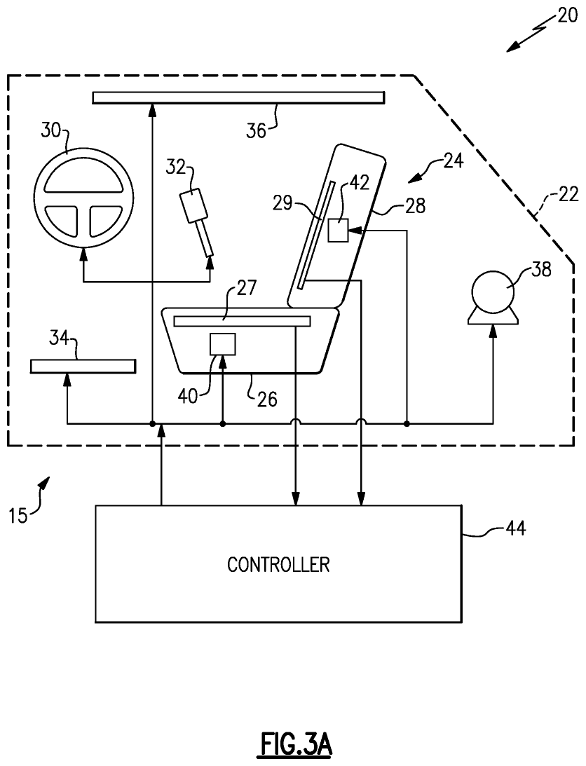

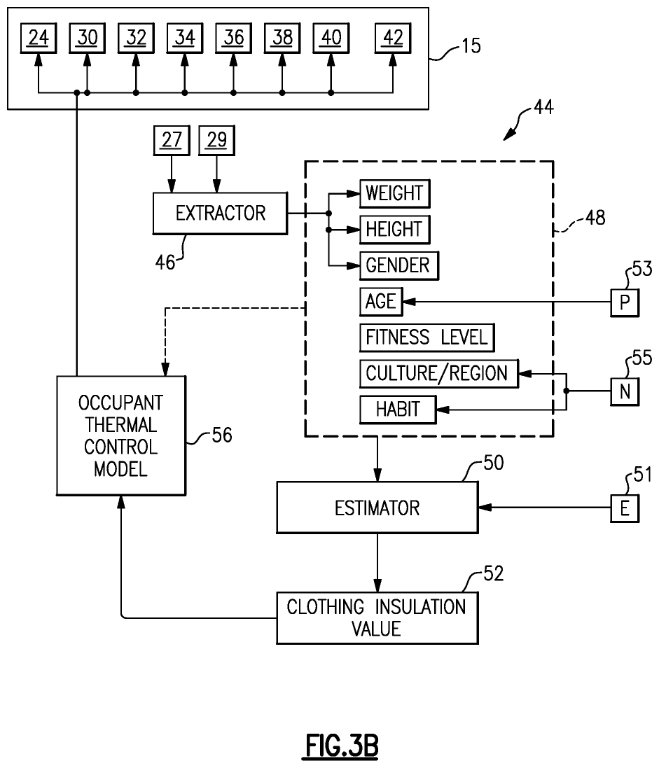

FIG. 1A illustrates a method 100 of collecting data associated with a thermal control system through real-world testing. In one example, real-world vehicle testing with live occupants in varying environmental conditions. The method 100 includes several steps that collect differing types of data associated with the real-world vehicle testing, and combines the differing types of data into a master dataset 80 (FIG. 1A) that is ultimately be used to predict initial set point values for thermal effectors 15 (FIGS. 3A and 3B).

The method 100 includes a step 102 of performing real-world vehicle tests with multiple different occupants. During step 102 a vehicle is operated over a range of environmental conditions and a thermal control system in the vehicle or occupant operates thermal effectors 15 associated with the corresponding occupant. For example, the vehicle or occupant may control thermal effectors 15 which include a heated and cooled seat back and cushion. In one example step 102, the test includes a plurality of thermal effectors 15 associated with the occupant as part of a vehicle microclimate system 20 as explained below. In some examples, the real-world tests performed in step 102 are performed over a wide variety of environmental conditions, such as a wide range of temperatures (ex. -20C to +40C), precipitation types, and solar loads (low or no sun load to high sun load).

The method 100 includes a step 104 of collecting occupant personal parameters 48 of each occupant in the test in step 102. The occupant personal parameters 48 can include physical characteristics of the occupant such as height, weight, and gender, but can also include information such as age, body composition, nationality and health information. The occupant personal parameters 48 can be collected before, during or after the test in step 102. The occupant personal parameters are associated with other data or information collected about the occupant during the tests in step 102.

The method 100 includes a step 106 of collecting vehicle environmental conditions 49 that were observed or measured during the test in step 102. The vehicle environmental conditions can include the vehicle interior temperature, the ambient exterior temperature, solar load, humidity, precipitation, and other conditions that affect thermal control of a vehicle. The vehicle environmental conditions can be collected before, during or after the test in step 102, and associated with other data or information from the tests in step 102.

The method 100 includes a step 108 of collecting thermal effector set point values 58. The thermal effector set point values 58 are the values that are used to control a thermal effector to achieve a certain performance of the thermal effector. For example, the set point value of a seat back and cushion may be the desired temperature for the seat back and cushion. The thermal effector set point values 58 can be collected before, during or after the test in step 102, and are associated with other data or information from the tests in step 102.

The method 100 includes a step 110 of collecting operating values 60. The operating values 60 are values that indicate a certain performance of the microclimate control system 20 or thermal effectors 15. For example, the operating value 60 may be the occupant's perception of thermal comfort 62, as indicated by the occupant either directly by an input of comfort or discomfort, varying levels of comfort during or after the test in step 102.

The operating value 60 may also be the operating value of the thermal effector during the test in step 102, such as energy consumption in Watts. In this instance the energy consumption can be used to determine the heat transferred to the occupant at varying conditions during the test in step 102. The energy consumption can be collected before, during or after the test in step 102, and associated with other data or information from the tests in step 102.

The method 100 includes a step 112 of storing the data collected in steps 104-110 as a data subset 70, wherein the each of the pieces of data collected in steps 104-110 is associated together for an occupant at a particular time. The data subset 70 allows the data to be analyzed as described herein based on one or more of the parameters, conditions, and values to determine simple relationships with another of the parameters, conditions, and values, or complex relationships with several of the parameters, conditions and values.

In one practical example, a large number of tests in step 102 are performed for a large number of different occupants, with differing occupant personal parameters 48, over a large number of environmental conditions 49, while collecting thermal effector set point values 58 and operating values 60. As such, a large number of datasets 70 are likely to be created and stored. In order to determine relationships across several different data subsets 70, the method 114 includes the step of storing the data subsets as a master dataset 80. Ideally, the master dataset 80 will include more than 10,000 datasets, and preferably more than 50,000 datasets. In one example, datasets 75 are stored in the form of rows with the each of the occupant personal parameters 48, environmental conditions 49, set point values 58 and operating values 60 in each row. In alternative examples, the datasets 75 may be stored in other formats.

With further reference to the real-world tests performed in step 102, an improved master dataset 80 is achieved when the tests include a variety of occupants. Ideally, the occupants have differing physical characteristics, such as height, weight, body composition and gender. Real-world tests including occupants having varying age, nationality and health can further improve the master data set 80.

FIG. 1B includes several charts that were created from the master dataset 80. Specifically, the charts graphically show some relationships or correlations between occupant personal parameters 48 of weight, height, and gender; environmental condition 49 of ambient temperature; and operating value 60 of thermal effector, specifically the control temperature of the seat back and cushion, for occupants that experienced thermal comfort. As can be observed, the differences in preferred thermal effector back and cushion temperatures vary widely. Some correlations can be drawn from the data in the master data set 80, which would be valuable to optimally control a thermal conditioning system. However, it is difficult to create a meaningful equation or control model to properly account for several personal parameters and operating conditions simultaneously to control thermal effectors 15, such as through determining a set point. Even if possible, to create such an equation or control model, the amount of computing time and effort to obtain such would be inefficient and cost prohibitive. Therefore, there exists a need to have a simplified method to predict a set point for a thermal effector.

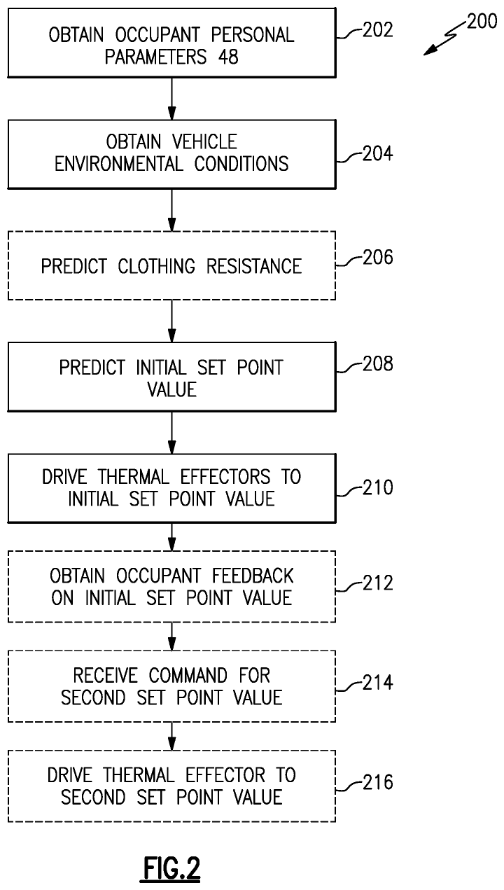

FIG. 2 illustrates an embodiment of the method 200 for controlling a vehicle microclimate system 20, shown in FIGS. 3A and 3B. With continuing reference to FIG. 3A and 3B, in step 202 occupant personal parameters 48 for an occupant are obtained. The occupant personal parameters 48 include, for example, an occupant weight, an occupant height, and an occupant gender. The occupant personal parameters 48 may be obtained directly from the occupant or another device where the occupant personal parameters 48 are stored, such as from an electronic device associated with the vehicle (e.g. a vehicle control unit), or electronic device associated with the user (e.g. a wearable device, smartphone, or key fob). The occupant personal parameter 48 may also be obtained from sensors within the vehicle, such as by measuring an occupant pressure distribution on a seat 24.

An example portion of a vehicle microclimate control system 20 is shown in more detail in FIG. 3A. A seat 24 includes a cushion 26 and a back 28 that supports an occupant. The cushion 26 includes a first array of pressure sensors 27, and the back 28 includes a second array of pressure sensors 29. The first and second arrays of pressure sensors 27, 29 measure an occupant pressure distribution from which the occupant personal parameters 48 can be determined. Cushion and back occupant outputs are provided by the first and second arrays of pressure sensors 27, 29 to provide a load distribution. It should be understood that either load or pressure may be provided by the sensors, and these terms may be used interchangeably in this disclosure.

The system 20 includes a controller 44 that may comprise one or more processors, hardware and/or software. The controller 44, shown in more detail in FIG. 3B, includes an extractor 46 that is in communication with the first and second arrays of pressure sensors 27, 29. The extractor 46 receives the pressure signals from the arrays and compares the cushion and back occupant outputs to one or more models to extract the occupant personal parameters 48. These models may be determined empirically by performing a linear regression on a training data set for each of the occupant personal parameters. An example regularized linear regression over activated k sensors is as follows: y=a+θ₁x₁+θ₂x₂+ . . . +θₖxₖ With the constriction to minimize the cost function J(θ)=MSE(θ)+λ/2Σ^{k}/i=1θ²ᵢ, where MSE is the mean squared error which is a function of the set of coefficients θ={θ₁, θ₂, . . . θₖ} of the input vector x with k components, and λ is a regularization constant.

The accuracy of the training set is then evaluated during development of the models based upon a test set to corroborate the model.

In one example, data from the cushion and back occupant outputs correspond to occupant anthropometric characteristics which may then be used to infer at least one of occupant weight, occupant height and occupant gender, the occupant personal parameters. Inputs from pressure sensors at particular locations may be given greater weight in the analysis.

Occupant weight may be inferred from the summation of the magnitude of the pressure sensed by the back and cushion pressure sensors. Fewer sensors sensing a lower pressure would be indicative of a lighter occupant, whereas more sensors sensing a comparatively higher pressure would be indicative of a heavier occupant.

Data from the cushion and back occupant outputs may also be used to determine occupant center of gravity. The occupant center of gravity can, in turn, be used to infer occupant gender from which the gender may be inferred. Studies indicate that the center of gravity for a female is approximately one inch lower than that of a male. This difference in center of gravity can be sensed by the pressure distributions on the cushion 26 and the back 28.

The occupant height can be inferred from the pressure distribution on the cushion. Typically, a taller person will have a more concentrated pressure distribution at the rear of the seat where the cushion meets the back. Additionally, the occupant height may also be inferred from the pressure distribution on the back which will manifest itself in pressure being sensed at a location farther from the cushion which is indicative of a taller occupant.

In step 204 (FIG. 2), the vehicle environmental conditions 49 are obtained. To this end, an environmental sensor 51 is exposed to air outside or inside of the vehicle. The environmental sensor 51 provides environmental data, which may be provided over a CAN or LIN bus, based upon at least one of outside air temperature, outside humidity, inside temperature and inside humidity. It should be understood that the environmental data may instead be provided by a transfer function based upon other inputs indicative of outside air. In one example, the vehicle environmental condition 49 is the ambient temperature outside the vehicle.

In step 206 (FIG. 2), optionally, the occupant personal parameters (48 in FIG. 3B) may then be used to estimate an occupant clothing insulation value 52, generally the insulation value 52 takes the form of a resistance value. The occupant clothing insulation value 52 affects the ability of the microclimate control system 20 to accurately control the various thermal effectors 15 within system 20. Of course, the amount of clothing an occupant may wear is typically affected by environmental conditions. More clothing is generally worn in colder temperatures, and less clothing is generally worn in warmer temperatures. This environmental condition 49 can be used to infer the effects of clothing selection by the occupant which may be used to adjust the occupant clothing insulation value 52 beyond the value estimated from the pressure distribution on the seat. Further, the magnitude of the changes in amount of clothing is larger in females than in males. By way of example, females tend to dress heavier for winter than comparable males and dress lighter for summer than comparable males.

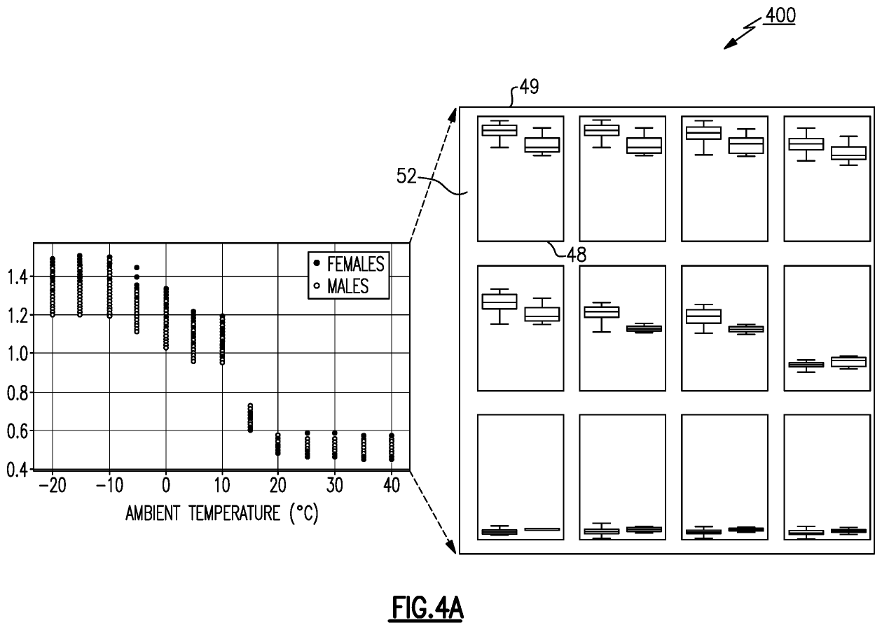

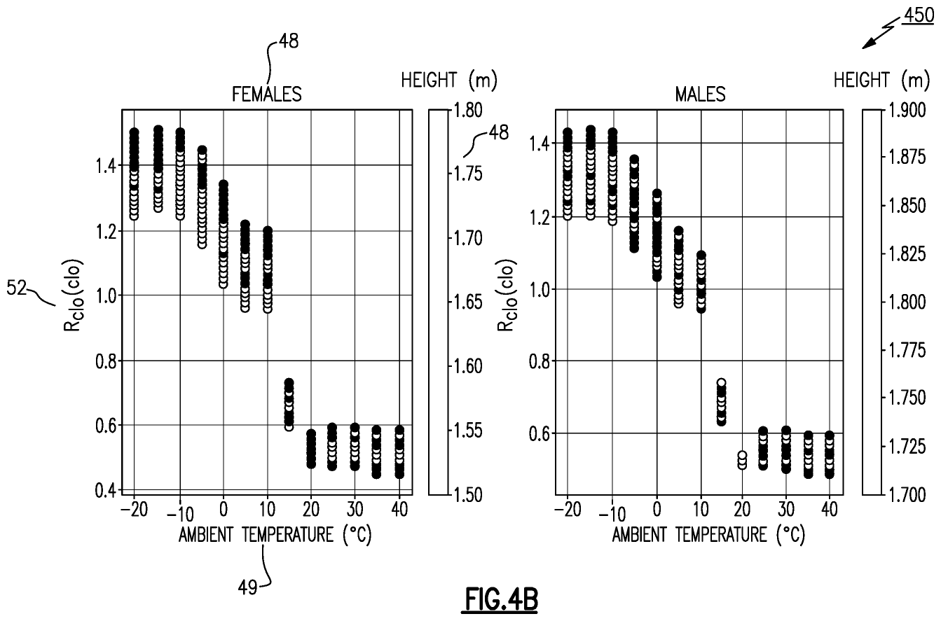

FIG. 4A shows a set of charts 400 that graphically depict the variance in clothing resistance across a group of occupants and temperature ranges. Charts 400 illustrate utilizing a portion of the master dataset 80, particularly a portion of the master dataset 80 that relates to female occupants. As shown in FIG. 4A, the charts show relationships of the clothing insulation value 52 for various occupant personal parameters 48 and for various environmental conditions 49. The clothing insulation value 52 may be used in step 206 as part of the method 200 to predict the initial set point value for the thermal effectors 15.

FIG. 4B shows a set of charts graphically depicting the variance in clothing resistance across a group of occupants of varying height and temperature ranges. Charts 450 illustrate utilizing a portion of the master dataset 80, particularly a portion of the master dataset 80 that relates to the occupant personal parameter 48 of occupant height and gender. As shown in FIG. 4B, the charts show relationships of the clothing insulation value 52 for various occupant personal parameters 48 and for various environmental conditions 49.

The occupant personal parameters 48 that the extractor 46 is able to determine from the seat are limited (e.g., weight, height and gender). The limitation affects the accuracy of the clothing insulation value 52 estimate. This estimate can be made more accurate by providing additional occupant personal parameters, such as occupant age, occupant culture, occupant region and/or occupant habit, to the estimator 50. Personalized devices 53, such as cell phones and watches, may also communicate with the controller 44 to provide relevant data to the estimator 50. Such data may include occupant age or location data from navigational tools 55, which can be used to determine occupant culture occupant region and/or occupant habits. Occupant fitness may be provided as an additional occupant personal parameter, for example, using heart rate variability (HRV) indices. The occupant fitness assessment cannot be done in a one-off fashion. Rather, a fitness parameter of an occupant is tracked over a period of time and then compared against a database/known data. Personal devices like watches, fitness trackers, or any similar devices are suitable for this purpose. The fitness level aspect of the estimator algorithm can be used when the statistical confidence becomes significant.

The amount of clothing worn by the occupant may also be affected by cultural preferences and regional considerations. That is, some cultural and regional preferences may indicate less or more clothing is worn by the occupant. To this end, the navigation tools 55 may be used to provide the occupant and/or vehicle location, which can be used to infer the climate, region, culture and/or environmental data.

The vehicle location can be used to infer occupant habits, such as the occupant habitually visiting a fitness center, which can affect the occupant's clothing choices. For example, the occupant may be hot and sweaty when leaving a fitness center such that less clothing is worn by the occupant than would otherwise be predicted from the environmental data and/or the estimated occupant clothing insulation value 52.

The clothing insulation value 52 may be provided to the thermal control model as a class or category. One example classification is provided in the Table below, which is a byproduct of performing a nonlinear regression analysis on data including environmental temperature, weight, height and gender.

| CLASS | CLOTHING VALUE | CLOTHING CONDITION |
|---|---|---|
| 0 | <0.6 | Little clothing |
| 1 | 0.6-0.8 | |
| 2 | 0.8-1.0 | Moderate clothing |
| 3 | 1.0-1.2 | |
| 4 | >1.2 | Heavily clothed |

The disclosed method and system is able to estimate the clothing insulation value 52 due to the strong correlation captured by the combined effect of environmental temperature, occupant height, occupant weight, occupant gender. This correlation may be further strengthened by also providing age and other occupant personal parameters 48 as inputs into the estimator 50, although these additional occupant personal parameters 48 generally have only a slight effect on the estimated clothing insulation value 52 compared to the combined effect of environmental temperature, occupant height, occupant weight, occupant gender.

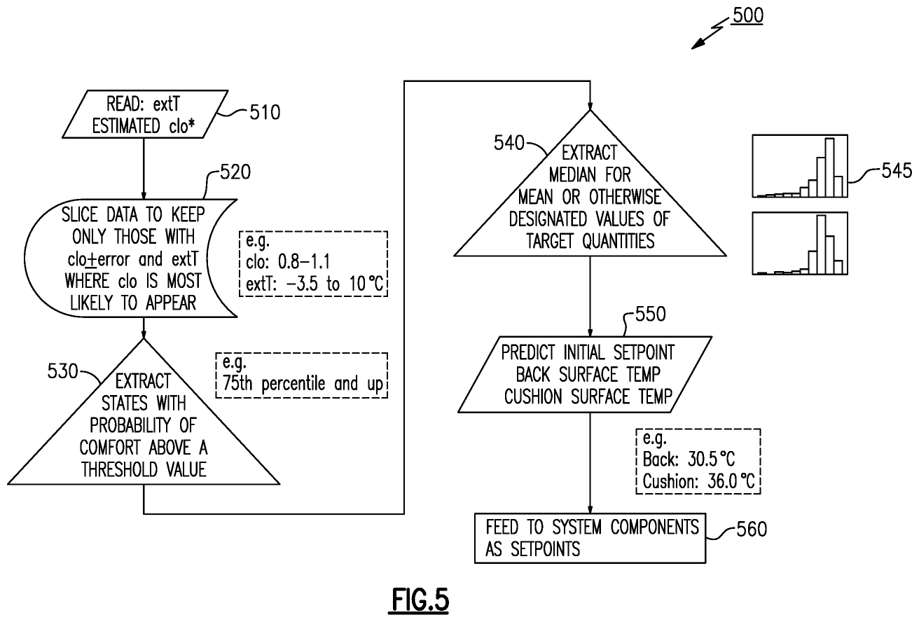

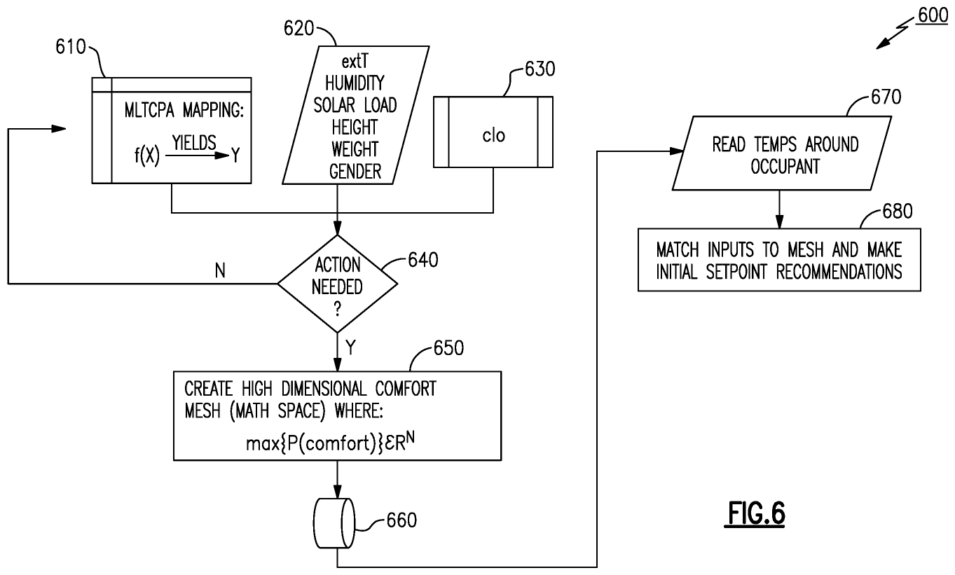

In step 208 (FIG. 2), the initial set points values are determined for a plurality of thermal effectors 15. The initial set point values 220 may be determined by using the occupant personal parameters 48 and the environmental conditions 49 collected from the occupant. Specifically, the initial set point values may be predicted through the use of the master dataset 80 as obtained through the method 100, or other large collection of data that includes occupant personal parameters 48, environmental conditions 49, and thermal effector set point values 58. Step 208 may be performed using several different methods as shown in FIGS. 5 and 6. In one example, step 208 utilizes a portion of the master dataset 80 or portion of another collection of data. In step 208, the portion of the master dataset 80 is analyzed based on the occupant personal parameters 48 detected or obtained by system 20 and the environmental conditions 49 to predict the initial set point value. Step 208, by using only a portion of the master dataset 80 improves the prediction accuracy and processing speed and resources to predict the initial set point value 220. Data from the

In step 210, the system 20 drives or regulates the thermal effector to the predicted initial set point value 220. In one example, in step 210 the initial set point value 220 is sent to the thermal effectors 15, either directly or from a controller. The thermal effectors 15 are then operated and seek to obtain the initial set point value to provide improved comfort to the occupant.

In step 212, an optional step, obtaining occupant feedback on the initial set point value can be performed. In this step, the occupant may provide an indication whether the initial set point value 220 was comfortable for the occupant. The feedback can be in the form of a simple binary command of comfortable or uncomfortable, or can include multiple levels of feedback associated with the comfort experience by the occupant from the initial set point value 220. The feedback may be used to further refine or control the prediction of the initial set point value in step 208.

In step 214, an optional step, obtaining a command for a second set point value 240 may be performed. In this step, the occupant or a controller may provide a second set point value 240 to the thermal effectors 15. In the case where the second set point is supplied by the occupant, the second set point value may be an operating value such as a new temperature or other operational value for the thermal effectors 15 desired by the occupant after the initial set point value. In the case where the second set point is supplied by the controller, the second set point value may be part of an automatic control of thermal effectors 15, which may be preferable after the thermal effector has begun operation toward the initial set point value 220 or has achieved the initial set point value.

In step 216, an optional step, the system 20 may drive or regulate the thermal effector to the second set point value 240. Preferably, in step 216 the second set point value 240 is sent to the thermal effectors 15, either directly or from a controller. The thermal effector is then operated and seeks to obtain the second set point value 240 to provide improved comfort to the occupant.

FIG. 5 illustrates an example of a method 500 to predict an initial set point value 220 for the thermal effectors 15 as part of step 208. The method 500 can be performed locally within a vehicle, or remotely via cloud computing distributed computing services or any other remote computing configuration, depending on the connections and processing power of the individual vehicle. Method 500 includes a step 510 for reading the environmental condition 49, such as the exterior temperature, and estimating the clothing insulation value 52 in accordance with any of the methods described in this disclosure.

In step 520, a portion of the master dataset 80 is selected to reduce the amount of data that is considered or processed in the prediction step 208. Specifically, in step 520 only data subsets 75 that relate to the read environmental condition 49 and the estimate clothing insulation value 52 in step 510 are selected for processing. For example, only data subsets 75 within a range of values that are around the values read in step 510 are considered. The range may be in the form of an error, e.g. +/− the values read in step 510, or include discrete values around the values read in step 510. In the example in FIG. 5 based on the values read in step 510, the range of clothing insulation values 52 is a range of 0.8 to 1.1, and the environmental condition 49 of exterior temperature is −3.5 C to 10 C.

In step 530, the data subsets selected in step 520 are further reduced by selecting only datasets with a probability of comfort (i.e. thermal comfort 62) above a threshold value. The probability selection in step 530 utilizes probability calculations to determine the probability that the occupant is comfortable, above a certain threshold. In one example the probability of 75^{th} percentile is used.

In step 540, the data subsets selected in step 530 are statistically analyzed to determine which set point values may be suitable as an initial set point value. For example, the data subsets selected in step 540 may be statistically analyzed to determine the mean, median, or other value that indicates a significance of a set point value in the data subsets selected in step 530. For example, as shown in the chart 545, step 540 may include creating a histogram of set point values.

In step 550, the initial set point values for each of the thermal effectors 15 to be controlled are selected based on the statistical analysis in step 540. In the chart 545, the histogram, the most common (i.e. the tallest value) may be selected as the initial set point value for the thermal effectors 15. Other values may also be selected based on the statistical analysis in step 530. The initial set point values selected in step 550 are a predicted initial set point value for the thermal effectors 15 at which the occupant will experience thermal comfort, based on a portion of the master dataset 80 that correlates to the obtained values in steps 202, 204 and optionally 206. The predicted initial set points are obtained while minimizing the amount of data processed to create the prediction and improving the accuracy of the prediction by only selecting data subsets that are relevant to the present conditions and occupant. The initial set point value is fed or communicated to the thermal effector under in step 560 or as part of step 210.

FIG. 6 illustrates another example of a method 600 to predict an initial set point value 220 for the thermal effectors 15 as part of step 208. Method 600 includes a step 610 for utilizing a machine learning algorithm to determine functions between various values in the master dataset 80. Step 620 includes obtaining several values, including occupant personal parameters 48 and environmental conditions 49. Step 630 calculates the clothing insulation value 52 based on any of the methods described in this disclosure.

The values obtained from steps 610, 620 and 630 are used in step 640 to determine whether any adjustment to the set point values of the thermal effectors 15 in microclimate system 20 is needed. Said another way, step 640 determines based on the values obtained in steps 620 and 630 applied to the algorithm in step 610, is the occupant likely not experiencing thermal comfort (i.e., is the occupant uncomfortable)? If the determination is Yes, action is needed to adjust the setpoints of the thermal effectors 15. If the determination is No, the occupant is likely experiencing thermal comfort, and no action is required.

In step 650, a high dimensional mesh is created using a portion of the master dataset 80. The high dimensional mesh can be used to obtain a function based on inverse mapping that will correlate conditions and parameters into a simplified model of temperatures in the vehicle at certain conditions. The model can be stored in step 660 and utilized later by step 670 to predict the temperatures proximate or around the occupant. In the case where the predicted temperatures around the occupant are below the expected values, the high dimensional mesh can be used to determine set points for the thermal effectors 15 required to obtain a desired temperature around the occupant in step 670.

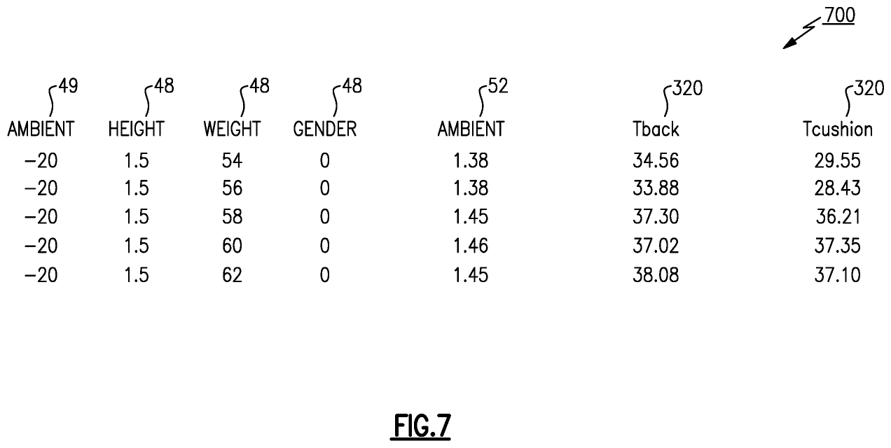

FIG. 7 is an example of a look-up table 700 for predicting an initial set point value. The look-up table was created by analyzing a portion of the master dataset 80 for a particular set of occupant personal parameters 48 and environmental conditions 49, and storing predicted initial set point values for a plurality of discrete occupant personal parameters 48, environmental conditions 49, and clothing insulation values 52. The look-up table may be a multi-dimensional look-up table wherein several values may be input to obtain the initial set point value. The look-up table may be stored in controller 44 of the microclimate system 20 or in another process that receives occupant personal parameters 48 and environmental conditions 49.

It should also be understood that although a particular component arrangement is disclosed in the illustrated embodiment, other arrangements will benefit herefrom. Although particular step sequences are shown, described, and claimed, it should be understood that steps may be performed in any order, separated or combined unless otherwise indicated and will still benefit from the present invention.

Although the different examples have specific components shown in the illustrations, embodiments of this invention are not limited to those particular combinations. It is possible to use some of the components or features from one of the examples in combination with features or components from another one of the examples.

Although an example embodiment has been disclosed, a worker of ordinary skill in this art would recognize that certain modifications would come within the scope of the claims. For that reason, the following claims should be studied to determine their true scope and content.

What is claimed is:

1. A method for controlling an occupant microclimate system, the method comprising the steps of:
determining an occupant personal parameter;
determining a vehicle environmental condition;
predicting an initial set point value for a plurality of thermal effectors associated with the occupant from a portion of a master dataset based on the occupant personal parameter and the vehicle environmental condition; and
regulating the plurality of thermal effectors based upon the initial set point values.

2. The method of claim 1, wherein the predicting step comprises;
selecting data subsets from a master dataset based on the occupant personal parameter and the vehicle environmental condition to create a reduced dataset, wherein the data subsets include set point values for the plurality of thermal effectors; and
extracting initial set point values for the plurality thermal effectors from the reduced dataset.

3. The method of claim 1, wherein the occupant personal parameter includes one of an occupant height, occupant weight and an occupant gender.

4. The method of claim 1, wherein the vehicle environmental condition includes one of a vehicle exterior temperature and a solar load.

5. The method of claim 1, wherein the step of determining an occupant personal parameter further includes the step of predicting an occupant clothing resistance based on the occupant personal parameter and the vehicle environmental condition.

6. The method of claim 5, wherein in the step of selecting data subsets from the master dataset, the occupant personal parameter is the predicted occupant clothing resistance.

7. The method of claim 5, wherein the step of selecting data subsets from the master dataset includes selecting data with a range of values based on the occupant personal parameter and the vehicle environmental condition.

8. The method of claim 1, wherein the master dataset includes a plurality of data subsets including an operating value.

9. The method of claim 8, wherein the operating value in the data subsets is a thermal comfort value obtained by physical testing.

10. The method of claim 8, wherein the operating value in the data subsets is an energy expenditure value of a thermal effector.

11. The method of claim 8, further comprising the step of selecting data subsets from a predetermined dataset based the operating value, wherein the selected data subsets have an operating value with a probability higher than a predetermined threshold.

12. The method of claim 1, wherein the step of extracting initial set point values for the plurality thermal effectors 15 from the reduced dataset comprises selecting an initial set point value that is one of the median and the mean of the reduced dataset.

13. The method of claim 1, wherein the step of predicting an initial set point value for a plurality of thermal effectors 15, includes inverse mapping a portion of a master dataset to create an equation for the initial set point value.

14. The method of claim 1, wherein the thermal effectors are proximal to the occupant and configured to provide thermal energy to the occupant.

15. The method of claim 1, wherein the thermal effectors are disposed in a seat for the occupant.

16. The method of claim 1, further comprising the step of obtaining an input from the occupant and adjusting a set point value of the thermal effector.

17. The method of claim 1, wherein the master dataset is determined via real world empirical testing and live occupants.

18. The method of claim 1, wherein the predicting an initial set point value includes selecting an initial set point value from a look-up table using the occupant personal parameter and vehicle environmental condition.

19. The method of claim 1, further comprising the step of regulating the thermal effector to a second set point value, different than the initial set point value after the step of regulating the thermal effector to the initial set point value.

20. The method of claim 1, wherein the step of regulating the plurality of thermal effectors is performed by a controller that regulates a plurality of thermal controllers for a plurality of occupants.

21. The method of claim 1, wherein the occupant personal parameter includes an occupant age, wherein the occupant age is obtained from an occupant's electronic device.

22. The method of claim 1, wherein the vehicle environmental condition includes a vehicle location, wherein the vehicle location is obtained via at least one of an occupant's device and a GPS signal received by the vehicle.
